(19) United States
(12) Patent Application Publication
(10) Pub. No.: US 2018/0270171 A1
(43) Pub. Date: Sep. 20, 2018

(54) METHOD ENABLING MESSAGE DELIVERY, A SYSTEM AND A COMPUTER PROGRAM PRODUCT

(71) Applicant: Iwan POSTEL, Gokturk (TR)

(72) Inventor: Iwan POSTEL, Gokturk (TR)

(21) Appl. No.: 15/541,477

(22) PCT Filed: Feb. 17, 2016
(86) PCT No.: PCT/IB2016/050851

§ 371 Date: Jul. 4, 2017

(30) Foreign Application Priority Data
Feb. 20, 2015 (NL) N2014330

(51) Int. Cl. H04L 12/58; H04L 29/06

(52) U.S. Cl. CPC H04L 51/02; H04L 51/30; H04L 51/046; H04L 63/12; H04L 51/14; H04L 51/32; H04L 51/38

(57) ABSTRACT

The invention relates to a method enabling message delivery between users, not necessarily all alive, of a digital communication system. The method includes a step of sending a checking message to a user to check whether a pre-defined event has occurred, the user having sent a pre-composed message with pre- selected recipients to the system, and having indicated at least one trusted other user of the system. Further, the method includes a step of sending a verifying message to the trusted user to verify whether the pre-defined event has occurred, if the system does not receive a response message from the user. If the trusted user sends a response message confirming that the pre-defined event has occurred, the system sends the pre-composed message to the pre-selected recipients.

The invention relates to a method enabling message delivery between users of a digital communication server.

Presently, social web-based applications are known offering several communication services such as chatting, posting data, e.g. images, to share, publish and/or sell content.

In order to meet an ongoing need for public and private communication services, it is an object of the invention to provide a method enabling an enhanced set of message delivery services. Thereto, according to the invention, the method comprises the steps of sending a checking message to a user to check whether a pre-defined event has occurred, the user having sent a pre-composed message with pre-selected recipients to the system, and having indicated at least one trusted other user of the system; if the system does not receive a response message from the user, sending a verifying message to the trusted user to verify whether the pre-defined event has occurred, and if the system receives a response message from the trusted user confirming that the pre-defined event has occurred, sending the pre-composed message to the pre-selected recipients. Then, it is secured that a pre-composed message is delivered to pre-selected recipients after a pre-identified event happens.

The invention also relates to a system.

Further, the invention relates to a computer program product. A computer program product may comprise a set of computer executable instructions stored on a data carrier, such as a flash memory, a CD or a DVD. The set of computer executable instructions, which allow a programmable computer to carry out the method as defined above, may also be available for downloading from a remote server, for example via the Internet, e.g. as an app.

Other advantageous options and embodiments according to the invention are described in the following claims.

By way of example only, embodiments of the present invention will now be described with reference to the accompanying figures in which

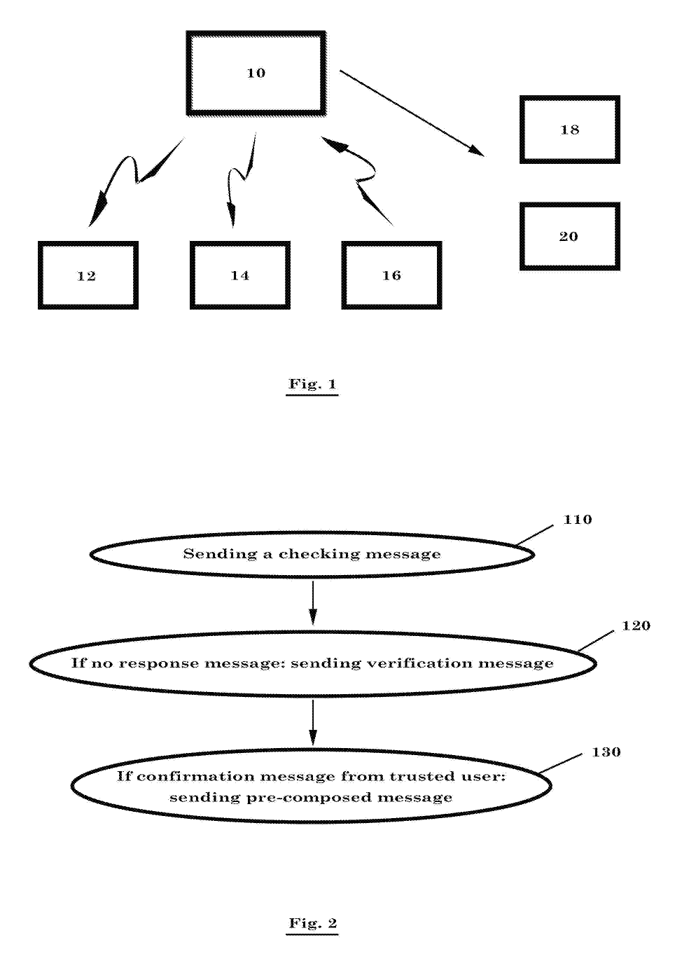

FIG. 1 shows a schematic view of a digital communication system according to the invention, and

FIG. 2 shows a flow chart of an embodiment of a method according to the invention.

The figures merely illustrate preferred embodiments according to the invention. In the figures, the same reference numbers refer to equal or corresponding parts.

FIG. 1 shows a schematic view of a digital communication system 10 according to the invention. The system 10 enables and supports message delivery between portable communication devices 12, 14, 16 of users that are communicately connected to the system 10.

The system 10 may be implemented as a server or a distributed system of servers, e.g. web-based. The portable communication devices 12, 14, 16 can be any electronic device that is able to communicate with the system 10, such as cell phones, smartphones, tablets, laptops, desktops, PC's etc.

In a particular embodiment, the system 10 is arranged for supporting a service of delivering a pre-composed message to pre-selected recipients in a secure way after a pre-identified event has occurred to a user.

Thereto, a user 12 sends a pre-composed message with pre-selected recipients 18, 20 to the system 10, and indicates at least one trusted other user 14, 16 of the system 10. The system 10 repeatedly sends a checking message to the user 12 to check whether a pre-defined event has occurred or not. If the user 12 indicates that the event has not occurred, the system 10 sends another checking message after a pre-set time period. If the system 10 does not receive a response message from the user 12, the system sends a verifying message to the trusted user 14, 16 to verify whether the pre-defined event has occurred. Then, if the system receives a response message from the trusted user 14, 16 confirming that the pre-defined event has occurred, the system 10 sends the pre-composed message to the pre-selected recipients 18, 20. Then, according to the intention of the user, the pre-composed message is sent in a delayed manner to the pre-selected recipients without activating any device of the user itself.

The pre-defined event might be hospitalization, accident, an inability to respond to calls and/or emails, arrest, death, etc. The pre-composed message may include a text message, pictures, videos, files and/or other data. Further, the at least one trusted other user 14, 16 of the system may include a multiple number of trusted users, such as three or five trusted users, also called trustees and/or trusted friends.

Throughout the description, the services are called WA-services. Similarly, users of the system are called WA-users.

The step of sending a verifying message to the trusted user 14, 16 is also executed if the user 12 states, in a response message sent to the system 10, that the pre-defined event has occurred.

The system 10 is a social application that can be accessed from a computer, smartphone, tablet and other products connected to the Internet, preferably using encryption that does not share/publish/sell your private information/data/content with unauthorized third parties. Once the first trustees e.g. five trustees have been verified a WA-membership is completed and may include the following services/features.

In a specific embodiment, the service of delayed delivery of messages may include a so-called WA-event, a WA-after, a WA-testament or a WA-RiRP.

In the WA-event service a message is composed now but needs to be delivered only after a specific event occurs to the user in the very near future (arrest, hospitalization, an accident, inability to respond to calls and/or emails sent to you to check your vital status, etc). The user selects a minimum 3 trustees for each WA-event message and the ‘event’ must first be confirmed by a majority (thus at least 2) of the pre-selected trustees and then the WA-app software will automatically send the message to its recipient(s). The “vital check” procedure sends you a message asking the user to confirm the user's well being after a by the user predetermined period (hourly, daily or weekly) or after a predefined period of inactivity. These messages will be repeated, until the moment the user respond. If the user does not respond to this “vital check” the system sends a message to the trustees asking for the user's well-being and if they confirm an ‘event’ has taken place and the user is unable to respond, the WA-event will be sent to its recipient(s). If a WA-event has not been cancelled and/or if for whatever reasons the WA-event is still in the system the 180th day, then the system will send the user a last warning message giving the user the opportunity to postpone the WA-event. If the user does not react and before deleting the WA-event message automatically, the system sends a last message to the trustees who will either confirm that the WA-event needs to be sent or that it can be deleted from the system.

In the “WA-after” service a message the user composes now but needs to be delivered only after the user passes away. The user preferably selects minimum 5 trustees for each WA-after message and the user's “passing away” must of course first be definitely confirmed by at least some of the trustees, e.g. 3 of the preselected trustees (by the “vital check” system) before the WA-app software will automatically send the message to its recipient(s). WA-after messages may have a certain validity period after which the user will be proposed to either renew or delete it! Our “vital check” procedure sends the user a message asking you to confirm his or hers well being after a pre-determined period (Monthly, quarterly, semiannual or yearly) or after a certain period of inactivity! These messages will be repeated, until the moment the user responds within the predefined period of time. If the user does not respond to this “vital check” the system sends a message to the trustees asking for the user's well being and if a majority (at least 3) of the trusted friends confirm the user's passing away, the WA-after will be sent to its recipient(s). If a WA-after is not auto destructed and/or if a WA-after has not been renewed or cancelled and/or if for whatever reasons the WA-after is still in the systems at the end of the 10th year after its creation, then the “vital check” procedure will apply and request a reply from at least 3 of the user's trustees to confirm the user's passing away. If they do not confirm the user's passing away the WA-after will be deleted from the systems.

The WA-testament service is dedicated to “last social wishes”. Inside WA-app, like in real life, the user should only have 1 testament and 1 only. Nonetheless WA-testament is more than just a Testament as besides a to be filled-in form of 2 or more pages that could be considered as the user's Last Will and Testament we added an extra option for WA-users enabling them to also attach pictures, a file, an audio or a video for their next of kin but please note that only the filled-in form could be considered as a Testament and Last Will. If the user wants to send simple afterlife messages the user can produce as many as he/she wants under the WA-after section. The user must have at least 2 witnesses and select minimum 5 trustees for the WA-testament and the user's “passing away” must of course first be definitely confirmed by a majority of the pre-selected trustees before the WA-app software will automatically send the WA-testament to its recipient(s). Our “vital check” procedure sends the user a message asking the user to confirm his/hers well being after a pre-determined period (Monthly, quarterly, semiannual or yearly) or after a certain period of inactivity. These messages will be repeated, until the moment the user responds within a predefined period of time. If the user does not respond to this “vital check” the system sends a message to the trustees asking for the user's well being and if at least a majority confirm the user's passing away, the user's ‘social’ WA-testament will be sent to its recipient(s). Depending on the type of membership the user's WA-Testament will cost a certain amount of money or WA-credits and each replacement with a new one will be charged extra money or extra WA-credits. Also our software will calculate the extra money or WA-credits needed (if any) according multiple specificities of the membership level and/or eventual attachments to the WA-testament. Note: It is probably easier to create a WA-testament from the user's computer.

The WA-RiRP (Rest in Real Peace) donations are dedicated to WA-users who are set to have an extremely high probability of passing away within a very short period of time (incurable diseases or very old and ill people) and who leave nothing except debts behind for their heirs or other loved ones. Some of these WA-users can be selected for our WA-RiRP donations that will help the loved ones to cope with the consequences of losing the WA-user who was responsible financially for them and could not leave anything behind (thing of studies monies for example).

As a further aspect of the invention, the method may include initiating all kind of post-mortem services preset/created by the WA-user or randomly created by the software. These services would be triggered from the moment a WA-user is confirmed as ‘passed away’ by his/her trusted friends. This is to be found under our ‘Eternity’ membership services and is thus dedicated to make WA-users virtually eternal. WA-users can preset all kind of activities for their account that will only be activated after their passing away. WA-users can opt-in or they can op-out for these services. If a WA-user is confirmed to have passed away on a certain date he/she can thus have previously opted to start his/her afterlife from that very same day he/she passed away and continue ageing (physical appearance and voice will get older). Only WA-contacts who have opted into this service and who are connected to each other inside the WA-services can continue communicate with each other even if one of them is not alive anymore but is now in his/her afterlife life. The software will send auto responses to any message sent by a living WA-user to a deceased WA-user who had previously opted into the ‘eternity’ services. When it comes to these automatic responses created by the software and based on real answers given by the deceased user when still alive or on the habits of the deceased WA-user before his/her passing away or based on the media material we can receive from friends or family of the deceased WA-user. It is also possible to create ‘eternity’ memberships and thus new WA-users for already deceased individuals. The software will analyze video and audio material from when they were alive and create a new virtual profile. The aim is also to generally send very positive and inspiring auto responses to the messages sent to ‘eternal’ members. WA-users may also preset all kind of afterlife profile changes and programming of messages to be sent at specific dates and/or times and/or for a specific event (anniversaries, holidays, new year and other celebrations).

According to a further aspect of the invention, the method may include initiating a timer after the user has activated an alert service of the system and has sent a pre-defined alarm message with pre-selected recipients to the system. If the system receives a reset signal prior to a pre-defined timer instant, then resetting the timer. If the system has not received a reset signal prior to the pre-defined timer instant, then activating an alarm state and sending the pre-defined alarm message to the pre-selected recipients, so that a SOS functionality is provided

Advantageously, a process of recording image data and forwarding said image data to an alert system is initiated if the alarm state has been activated. Optionally, the image data is broadcasted, e.g. to a selected number of recipients. Further, optionally, location information such as GPS information is then forwarded to an alert system.

Additionally, the alarm state is activated if the system has not received a safety confirmation message from the user within a pre-set time period after the alert service has started.

Preferably, the alarm state can merely be terminated by a user-authenticated message.

WA-SOS: To Watch after a user and for the user's SAFETY an S.O.S. function may be implemented inside the WA-app, this function will enable the user to instantly alert the pre-selected (trusted) friends and/or other contacts by sending them an instant SOS distress message including the user's GPS position and a picture that can also be automatically posted on the user's Facebook page and/or a YouTube page(s) and/or a Twitter account. Members can also broadcast ‘live’ to pre-selected (trusted) friends and/or other contacts and send unstoppable short emergency ‘help me’ video recordings. They can also use extra SOS features specially made for unaccompanied children “WA-track” and/or other vulnerable people.

“WA-guard” who needs to be watched after in a very specific way. The system will calculate the money or WA-credits needed (if any) according multiple specificities related to the user's membership level and to the use of the SOS feature.

The system 10 may further enable chatting sessions between users of the system, wherein chatting users are admitted only if they use a pseudonym and if an access process using personalized authentication data has completed successfully, and wherein all chat session data of all chatting users are removed if an access process of a user attempting to being admitted to the chat session fails.

WA-ssh: A user can have REAL secret chats. A user must use a nickname and each of these secret chats is protected by its own 4-digit pin code, which has to be entered each and every single time you access them. In principle, also another authentication process can be applied, e.g. scanning a fingerprint of the user. A secret chat will be completely deleted if the user enters a wrong secret pin code twice! We will only keep secret messages on our servers for a few seconds (unless the user has set a different time), so those who are not connected when a message is sent in a group chat will not receive the message later. However, if the user sets a specific time for the deletion of the messages then the user decides when a message is deleted from the chat room and the server.

Further options of the system include the following.

WA-user and WA-guardian: A confirmed WA-app user is called WA-user. A WA-guardian is a WA-user who has been verified and is minimum 18 years old and who has accepted to be the guardian for a member who is under the age of 18. A WA-guardian takes full responsibility to care for, protect and preserve the rights and the obligations of an under aged WA-user.

WA-contact and TRUSTEE (also called trusted friend): As soon as you become a WA-user you can invite your friends to connect with you and those who accept, once verified, become your WA-contact. A TRUSTEE is a verified +18 WA-contact you fully trust for confidential matters and who can also easily verify your vital status in case the software can't reach you (see also our terms & conditions). You will need trustees for your WA-event and WA-after messages, for your WA-testament and also for some WA-SOS functions. To use all features of WA-app the user needs at least 1 but preferably more, e.g. 5 trustees but there is no limit in the number of trustees and the user generally only need a few of them.

WA-klik: You can have (encrypted in many countries) chats with all your contacts and send INSTANT or DELAYED (delivered up to 1 year later in a chat room without the need to be online) messages, pictures, videos, audio, location and contact details (maximum 17 MB per message). You can do this from your Smartphone, tablet, computer and other products connected to the Internet.

WA-translate: You can instantly translate a foreign received chat message (with automatic recognition of any foreign language) into your own (or any other) language WITHIN your chat room. VIP members maybe benefit from improved translations.

WA messages: A “WA-future” is a message the user composes now but needs to be delivered at a pre-defined, always later (maximum 50 years later), exact date and time.

WA-transfer: This is the storage and (safe) transfer of files platform/feature. In fact we already use it for all the WA's but basically here the user will be able to stock any file from the user's device such as phone and/or your computer and the user will be able to access these files anytime and from anywhere in the world or the user will be able to order the delivery of the user's files to one or multiple contacts at his/her convenience. The user can also transfer heavy files. The system will propose different options and will calculate the money or WA-credits needed (if any) according to multiple specificities of the WA-transfer(s).

WA-social: This is a marketing feature. The WA promotions, games, side services and/or payable features can be proposed to the user via notifications and the user will be able to earn WA-points and/or spend your WA-credits for those services/features. The user can also receive 3rd party offers for inside app games and/or ads/publicities but he/she will be able to disconnect these ads/publicities from third parties for free or for a certain amount of money or a certain number of WA-credits per year which you may already have earned automatically by having a certain number of trustees or WA-contacts (disconnecting third party ads/publicity can be free of charge if the user is a Premium member) and the user can always manually consult all WA-social offers in the user's account pages.

WA-settings: The user can choose between multiple colors for the WA-app general appearance but more important the user can decide about more detailed privacy settings than any other social app under your ‘settings’ page. The user can also disconnect third party ads/publicity for a certain fee per year which the user could have earned automatically by the time the user has confirmed trustees or WA-contacts (this service is free of charge for our premium members).

WA-swipe: The user can preset several preferred chat screens and swipe from one pre-selected screen to another, from left to right and back from right to left. Just imagine the user can switch from one chat conversation to another conversation just by a simple swipe on your screen and so on.

WA-voip: The user can instantly talk (with or without video streaming) with any of your online/connected WA-contacts through his/her Internet connection.

WA-flirt: When the user becomes a member he/she can choose to be open for ‘dating’. If the user does so then other WA-users who also accepted to be open for ‘dating’, even those not WA-contacts with the user, can see the user and vice-versa, this in a preset distance range around the user. After exchanging some private information, and if the two think they are a good match, they could start communicating/dating inside WA-app or organize their own real life ‘date’ and if the users are not 100% sure they can always use the WA-SOS feature to watch their back during their first meetings.

WA-wink: This function enables the user to auto delete pictures or videos once the recipient has opened them.

WA-smart: As a WA-user, during a membership, the user will receive a unique QR code making it easy to connect to other WA-users. The user will also have a digital wallet with WA-credits and WA-points to be used for upgrades and payable services. If the user becomes an intensive WA-user he/she will want to benefit from more advantages and better conditions and for this reason we have created a WA-smart program enabling the user to earn WA-points in order to upgrade to or maintain a VIP level membership without spending any money. Our WA-smart works similar to airline frequent flyer programs and/or affiliate programs; the higher level of membership the user is the more advantages he/she will benefit from. The more contacts he/she brings, the more trustees he/she has, the more he/she uses the app, etc, and the more WA-points he/she will earn and the less WA-credits he/she will need to buy.

It is noted that the SOS functionality can be implemented in combination with the method as defined in present claim 1. However, the SOS functionality can also be implemented, more generally, in a method enabling message delivery between users of a digital communication server. Then, the step of initiating a timer after the user has activated an alert service of the system and has sent a pre-defined alarm message with pre-selected recipients to the system, the step of resetting the timer if the system receives a reset signal prior to a pre-defined timer instant, and the step of activating an alarm state and sending the pre-defined alarm message to the pre-selected recipients if the system has not received a reset signal prior to the pre-defined timer instant can be implemented also in a method enabling message delivery between users of a digital communication system without a delayed message service.

FIG. 2 shows a flow chart of an embodiment of a method according to the invention. The method is used for enabling message delivery between users of a digital communication system, and comprises a step of sending 110 a checking message to a user to check whether a pre-defined event has occurred (this step can be repeated up to 3 times), the user having sent a pre-composed message with pre-selected recipients to the system, and having indicated at least one trusted other user of the system; a step of sending 120, if the system does not receive a response message from the user, a verifying message to the trusted user to verify whether the pre-defined event has occurred, and a step of sending 130, if the system receives a response message from the trusted user confirming that the pre-defined event has occurred, the pre-composed message to the pre-selected recipients.

The method of enabling message delivery between users of a digital communication system can be facilitated using dedicated hardware structures, such as computer servers. Otherwise, the method can also at least partially be performed using a computer program product comprising instructions for causing a processor of a computer system to facilitate message delivery. All (sub)steps can in principle be performed on a single processor. However, it is noted that at least one step can be performed on a separate processor. A processor can be loaded with a specific software module. Dedicated software modules can be provided, e.g. from the Internet.

The invention is not restricted to the embodiments described herein. It will be understood that many variants are possible.

These and other embodiments will be apparent for the person skilled in the art and are considered to fall within the scope of the invention as defined in the following claims. For the purpose of clarity and a concise description features are described herein as part of the same or separate embodiments. However, it will be appreciated that the scope of the invention may include embodiments having combinations of all or some of the features described.

1. A method enabling message delivery between users of a digital communication system, comprising the steps of:
sending a checking message to a user to check whether a pre-defined event has occurred, the user having sent a pre-composed message with pre-selected recipients to the system, and having indicated at least one trusted other user of the system;
if the system does not receive a response message from the user, sending a verifying message to the trusted user to verify whether the pre-defined event has occurred;
if the system receives a response message from the trusted user confirming that the pre-defined event has occurred, sending the pre-composed message to the pre-selected recipients;
initiating a timer after the user has activated an alert service of the system and has sent a pre-defined alarm message with pre-selected recipients to the system;
if the system receives a reset signal prior to a pre-defined timer instant, then resetting the timer; and
if the system has not received a reset signal prior to the pre-defined timer instant, then activating an alarm state and sending the pre-defined alarm message to the pre-selected recipients.

2. A method according to claim 1, wherein the step of sending a verifying message to the trusted user is also executed it' the user states, in a response message sent to the system, that the pre-defined event has occurred.

3. A method according to claim 1, wherein the step of sending a checking message is repeatedly executed.

4. A method according to claim 2, wherein the step of sending a checking message is repeatedly executed.

5. A method according to claim 1, further comprising the step of recording image data and forwarding said image data to an alert system, if the alarm state has been activated.

6. A method according to claim 1, further comprising the step of forwarding location information to an alert system, if the alarm state has been activated.

7. A method according to claim 1, wherein the alarm state is activated if the system has not received a safety confirmation message from the user within a pre-set time period after the alert service has started.

8. A method according to claim 1, wherein the alarm state can merely be terminated by a user-authenticated message.

9. A method according to claim 1, further enabling chat sessions between users of the system, wherein chatting users are admitted only if they use a pseudonym and if an access process using personalized authentication data has completed successfully, and wherein all chat session data of all chatting users are removed if an access process of a user attempting to being admitted to the chat session fails.

10. A method according to claim 1, further enabling message delivery between users where at least one of the users has passed away, wherein pre-recorded answers are used to pre-defined questions the deceased user has answered when still alive and/or auto-generated response messages are created based on the profile and habits of the deceased user when still alive.

11. A digital communication system enabling message delivery between users thereof, wherein the system is arranged for performing the steps of:
sending a checking message to a user to check whether a pre-defined event has occurred, the user having sent a pre-composed message with pre-selected recipients the system, and having indicated at least one trusted other user of the system;
if the system does not receive a response message from the user, sending a verifying message to the trusted user to verify whether the pre-defined event as occurred;
if the system receives a response message from their trusted user confirming that the pre-defined event has occurred, sending the pre-composed message to the pre-selected recipients;
if the system receives a message for a deceased user, using pre-recorded answers to pre-defined questions the deceased user has answered when still alive or using auto-generated response messages created based on the profile and habits of the deceased user when still alive;
initiating a timer after the user has activated an alert service of the system and has sent a pre-defined alarm message with pre-selected recipients to the system;
if the system receives a reset signal prior to a pre-defined timer instant, then resetting the timer; and
if the system has not received a reset signal prior to the pre-defined timer instant, then activating an alarm state and sending the pre-defined alarm message to the pre-selected recipients.

12. A digital communication system according to claim 11, wherein the system is communicately connected to a portable communication device of the user,

13. A computer program product for enabling message delivery between users of a digital communication system, the computer program product comprising a non-transitory computer readable data carrier retaining computer executable instructions which instructions when read by a processor, cause the processor to facilitate a process including the steps of:
sending a checking message to a user to check whether a pre-defined event has occurred, the user having sent a pre-composed message with pre-selected recipients to the system, and having indicated at least one trusted other user of the system;
if the system does not receive a response message from the user, sending a verifying message to the trusted user to verify whether the pre-defined event has occurred;
if the system receives a response message from the trusted user confirming that the pre-defined event has occurred, sending the pre-composed message to the pre-selected recipients;
if the system receives a message for a deceased user, using pre-recorded answers to pre-defined questions the deceased user has answered when still alive or using auto-generated response messages created based on the profile and habits of the deceased user when still alive;
initiating a timer after the user has activated an alert service of the system and has sent a pre-defined alarm message with pre-selected recipients to the system;
if the system receives a reset signal prior to a pre-defined timer instant, then resetting the timer; and
if the system has not received a reset signal prior to the pre-defined timer instant, then activating an alarm state and sending the pre-defined alarm message to the pre-selected recipients.
